(19) United States
(12) Patent Application Publication
(10) Pub. No.: US 2009/0040640 A1
(43) Pub. Date: Feb. 12, 2009

(54) Glass cutting method, glass for flat panel display thereof and flat panel display device using it

(76) Inventors: Jinnam Kim, Yongin-si (KR); Junghyuck Choi, Yongin-si (KR); Gyoowan Han, Yongin-si (KR)

Correspondence Address: ROBERT E. BUSHNELL & LAW FIRM, 2029 K STREET NW, SUITE 600, WASHINGTON, DC, 20006-1004, US

(21) Appl. No.: 12/222,370

(22) Filed: Aug. 7, 2008

(30) Foreign Application Priority Data
Aug. 7, 2007 (KR) 10-2007-0078951

(51) Int. Cl. G02B 5/00; B23K 26/38

(52) U.S. Cl. 359/894; 219/121.72; 219/121.6

(57) ABSTRACT

A glass cutting method and glass for a flat panel display. This glass cutting method forms crack regions of a constant size and pitch inside the glass using a laser and performs the full-through cutting process along the crack regions with a laser, thereby increasing cutting edge quality, shortening the cutting time and reducing the production cost.

### CLAIM OF PRIORITY

This application makes reference to, incorporates the same herein, and claims all benefits accruing under 35 U.S.C. §119 from an application earlier filed in the Korean Intellectual Property Office on 7 Aug. 2007 and there duly assigned Serial No. 10-2007-0078951.

### BACKGROUND OF THE INVENTION

1. Field of the Invention

The present invention relates to glass cutting method, glass for flat panel display thereof and flat panel display device using it.

2. Description of the Related Art

A plasma display device, for instance, forms a barrier rib and a phosphor layer between two thin substrates and injects an inert gas. Then, a high voltage is applied to the inert gas. As a result thereof, ultra-violet rays are emitted from an inert gas so as to excite the phosphor layer and the excited phosphor layer emits a visible ray.

Further, an organic light-emitting display device sequentially forms a semiconductor layer and an organic light-emitting layer on the substrate and applies a predetermined current (or voltage) to the semiconductor layer, so that the organic light-emitting layer emits the visible ray.

Additionally, a liquid crystal display device forms a semiconductor layer, a liquid crystal and a color filter and others between two thin substrates and applies a predetermined current (or voltage) to the semiconductor layer, so that light is emitted from the backlight to the outsurface through the color filter according to the molecular direction of the liquid crystal.

As described above, a general flat panel display device has used, as a transparent substrate, a substrate, in which since the size of the mother glass is larger than the actual size of a display device to be manufactured (eg. 40″, 50″, 60″ and the like), it is required to perform a glass cutting process according to the size of the display device.

Current glass cutting methods generally include a wheel cutting technique and a laser cutting technique. The wheel cutting technique is achieved by forming a scribe groove with a predetermined depth on the surface of the glass using a diamond wheel, and then mechanically warping the glass. Further, the laser cutting technique is also achieved by forming a scribe groove with a predetermined depth on the surface of the glass using laser, and then mechanically warping the glass. Ultimately, both these wheel and laser cutting techniques compulsively perform warping of the glass, so that great amounts of glass particles are generated during the cutting process. Such glass particles remain on the surface of the glass during a manufacturing process, thereby causing many defects.

Accordingly, a full-through laser cutting technique has been recently used, and is a technique that performs the full-through cutting of the glass using laser without mechanical warping. However, since the full-through laser cutting technique performs the full-through cutting of the glass, it takes a long time to cut the glass. Additionally, since the fill-through laser cutting technique is equipped with a laser source with a high output power, there is an increase in production cost. In other words, the full-through laser cutting technique is advantageous to perform the glass cutting without glass particles, however, it needs long processing time and further increases production cost by using an expensive laser apparatus.

### SUMMARY OF THE INVENTION

Accordingly, an aspect of the present invention is to provide glass cutting method, glass for flat panel display thereof and flat panel display device using it that can increase cutting edge quality, shorten the cutting time and reduce the processing cost, by forming crack regions with a constant size and pitch inside the glass with a laser and performing the full-through cutting process along the crack regions with the laser.

According to an aspect of the present invention, there is provided a glass cutting method for flat panel display device which may include forming crack region that outputs intermittently laser beams from a movable laser apparatus, so that crack regions are formed inside glass, and a full-through cutting that outputs continuously laser beams from the laser apparatus along the crack regions formed inside the glass so as to perform the full-through cutting of the glass.

According to another aspect of the present invention, there is provided glass for flat panel display device which may include a first surface, a second surface opposite to the first surface, and a third surface connecting the first and second surfaces, wherein at least one crack region formed with a laser in order to be guided on the third surface.

According to still another aspect of the present invention, there is provided a flat panel display device which may a first substrate, a display unit which is formed in the first substrate and indicates an image, and a second substrate which is formed on the top of the first substrate and seals the display unit hermetically, wherein at least one crack region is formed with a laser in order to be guided along the first substrate and the second substrate each outer peripheral surface.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a flowchart illustrating a glass cutting method of one embodiment of the present invention;

FIG. 2a is a plane diagram illustrating a status that crack regions are formed on the glass by laser in a glass cutting method of one embodiment of the present invention;

FIG. 2b is a plane diagram illustrating a status that a cutting edge is formed on the glass along the crack regions with a laser in the glass cutting method of one embodiment of the present invention;

FIG. 3 is a plane diagram illustrating a status that crack regions are formed on the glass by laser and a cutting edge is formed on the glass along the crack regions with the laser in a glass cutting method of another embodiment of the present invention;

FIG. 4a is a schematic perspective diagram illustrating a laser apparatus for cutting glass according to a glass cutting method of the present invention;

FIG. 4b is a schematic surface diagram illustrating the laser apparatus for cutting glass according to a glass cutting method of the present invention;

FIG. 5 is a cross-sectional diagram illustrating the laser apparatus for cutting glass according to a glass cutting method of the present invention; and

FIG. 6 is a cross-sectional diagram illustrating another laser apparatus for cutting glass according to a glass cutting method of the present invention.

FIG. 7a is a perspective diagram illustrating glass for a flat panel display device of another embodiment of the present invention;

FIG. 7b is a partial expanded diagram illustrating the glass of another embodiment of the present invention;

FIG. 7c is a partial expanded diagram illustrating an outer peripheral surface of the glass of another embodiment of the present invention;

FIG. 8 is an expanded perspective diagram illustrating glass for flat panel display device of another embodiment of the present invention;

FIG. 9 is a perspective diagram illustrating a status that two sheets of glass according to the present invention overlap each other;

FIG. 10 is a partial cross-sectional diagram illustrating one example of the plasma display panel using the glass according to the present invention;

FIG. 11 is a partial cross-sectional diagram illustrating another example of the organic light emitting display panel using the glass according to the present invention; and

FIG. 12 is a partial cross-sectional diagram illustrating another example of the liquid crystal display panel using the glass according to the present invention.

### DETAILED DESCRIPTION OF EXEMPLARY EMBODIMENTS

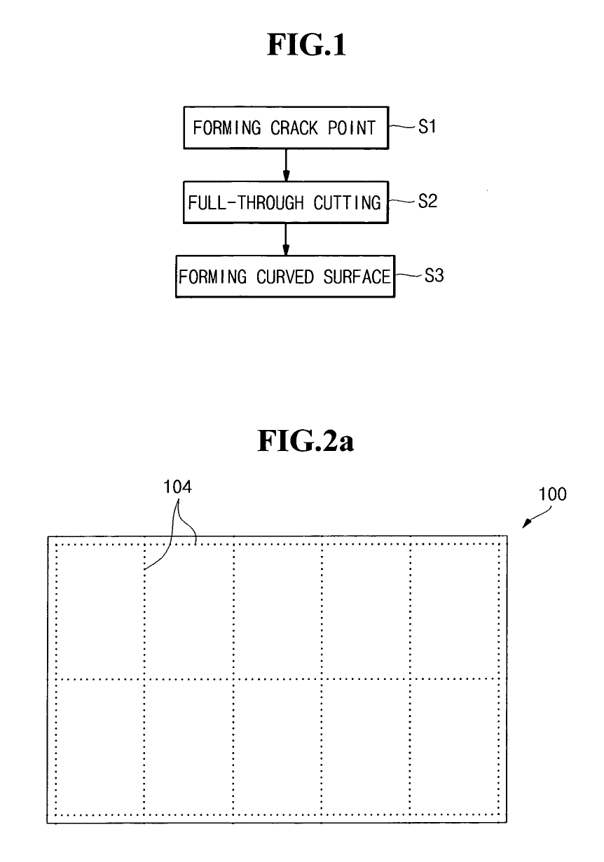

Referring to FIG. 1, a glass cutting method according to the present invention is illustrated by a flowchart.

The glass cutting method according to the present invention includes forming a crack region S1 and a full-through cutting S2. Additionally, either a curved surface or a chamfer is formed along the cutting edge S3.

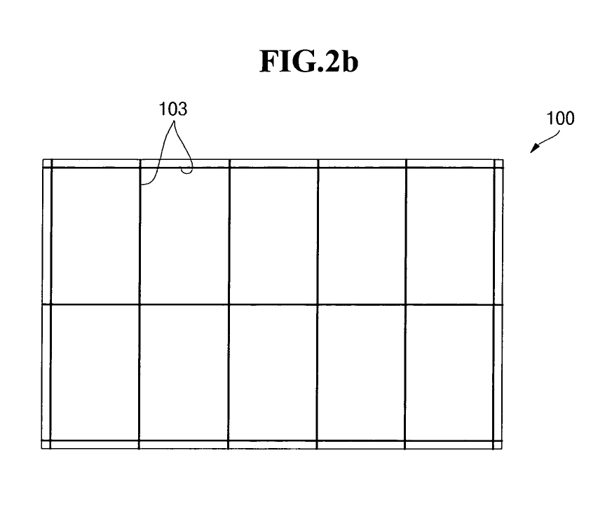

In forming the crack region S1, laser beams are output intermittently from a laser apparatus capable of moving in any X, Y and Z direction, so that crack regions with a constant size are formed at set pitches inside flat glass. For instance, as shown in FIG. 2a, the glass 100 is loaded and the crack regions 104 are then preformed inside the glass 100 along the cutting edge by outputting laser beams intermittently.

Here, it is desirable that the crack region 104 is formed in a size of approximately 1-20 μm. When the size of the crack region 104 is approximately 1 μm or less, the full-through laser cutting process may not be performed properly during the manufacturing process. Further, when the size thereof is approximately 2 μm or more, it overlaps with another neighboring crack region 104 so as to become oversized.

Further, it is desirable that the crack region 104 is formed at a pitch of approximately 5-40 μm. When the pitch of the crack region 104 is approximately 5 μm or less, several crack regions 104 overlap each other so as to become oversized. On the other hand, when the pitch of the crack region 104 is approximately 40 μm or more, the full-through laser cutting process may not be performed properly during the manufacturing process.

The crack region 104 is formed by focusing the laser beam on the approximate internal center of the glass 100. However, actually, when focusing the laser beam within the range of 10-90% of the thickness of the glass 100, the full-through laser cutting process is performed along the crack region without any problem. When the formation position of the crack region 104 is beyond the range of 10-90% of the thickness of the glass 100, the full-through laser cutting process may not be performed properly during the manufacturing process.

Further, the laser apparatus may be one apparatus selected from YAG laser apparatus and others, however, the present invention is not limited thereto.

Additionally, it is desirable that the laser beam with a wavelength of approximately 300-400 nm is used when forming the crack region 104. When the wavelength of the laser beam is approximately 300 nm or less, there is a great difference in the laser beam energy, so that the crack regions 104 may be formed excessively. The laser apparatus carries heavy workload. In addition, when the wavelength of the laser beam is approximately 400 nm or more, the laser beam energy may be too low to form the crack region 104 with a desirable size.

Additionally, the thickness of the glass 100 may be approximately 0.5-5 mm, but not limited thereto. In other words, the glass may have either a thickness of 0.5 mm or less or a thickness of 5 mm or more.

In the full-through cutting S2, laser beams are output continuously from the laser apparatus along the crack regions formed inside the glass, so that the full-through cutting of the glass is performed. Particularly, as shown in FIG. 2b, laser beams are output continuously along the preformed crack regions, so that the glass is divided into pieces. In the drawing, reference numeral 103 denotes a cutting edge.

Here, it is desirable that the laser beam with a wavelength of approximately 1000-1100 nm is used when performing the full-through cutting of the glass. When the wavelength of the laser beam is approximately 1000 nm or less, there is a great difference in the laser beam energy, so that the glass may be cut excessively. Additionally, when the wavelength of the laser beam is approximately 1100 nm or more, the laser beam energy may be too low to perform the full-through cutting process properly.

Meanwhile, the full-through cutting step S2 may be initiated after completion of the full-through cutting step S2 over the whole glass. Particularly, as shown in FIG. 2a, the crack regions 104 are preformed on the cutting region of the whole glass 100. Then, as shown in FIG. 2b, the full-through cutting of the glass is performed along the crack regions. The cutting edge 103 is accordingly formed on the glass 100.

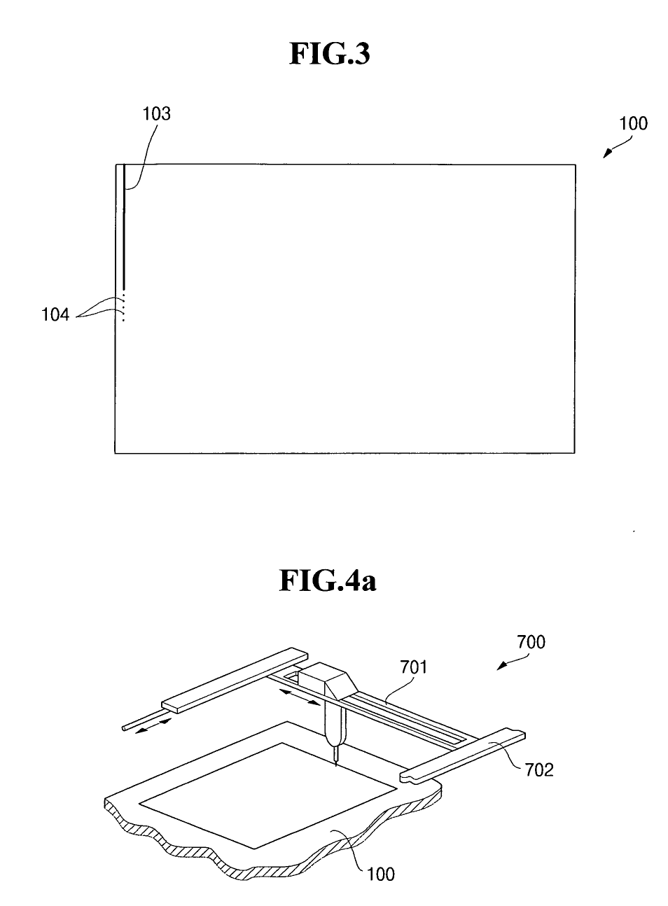

However, according to the present invention, as shown in FIG. 3, the crack forming and full-through cutting S1 and S2 may be performed approximately at the same time. Particularly, as shown in FIG. 3, the crack regions 104 are formed then followed by performing the full-through cutting of the glass 100 so as to form the cutting edge 103. The method illustrated in FIG. 3 may be equipped with two laser apparatuses.

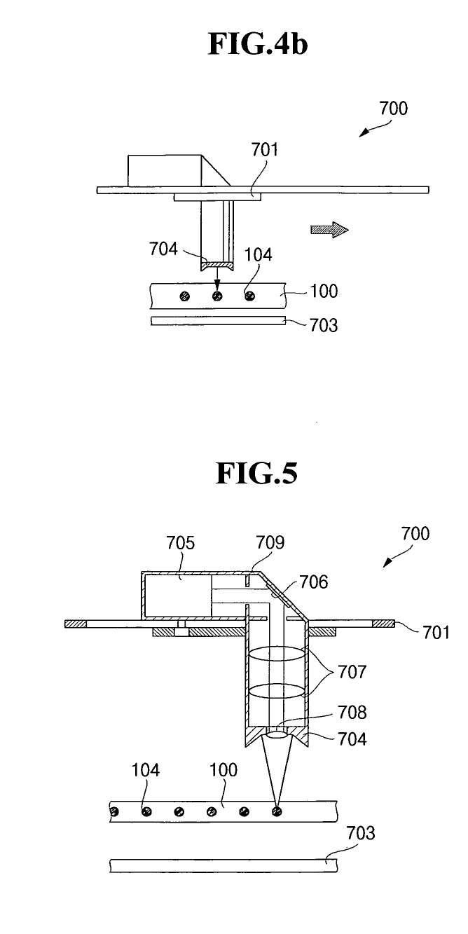

Referring to FIGS. 4a and 4b, a laser apparatus for glass cutting according to a glass cutting method of the present invention is illustrated by a schematic perspective diagram and a surface diagram.

Referring to FIG. 4a, the laser apparatus 700 is coupled to X directional guide rail 701 which is then coupled to the Y directional guide rail 702 again. The laser apparatus 700 may move in the X direction on the X directional guide rail 701 by a moving unit (not shown). Further, the X directional guide rail 701 may move in the Y direction on the Y directional guide rail 702 by a moving unit (not show). As a result thereof, the laser apparatus 700 can move in the X and Y directions. The laser apparatus 700 may move in the Z direction through an additional mechanical installation. Such structure is conventionally called XY table or XYZ table.

Referring to FIG. 4b, the laser apparatus 700 may further include a first reflective plate 703 positioned on the lower portion of the glass 100 so as to reflect the laser beam passing through the glass 100 toward the upper portion. Additionally, the laser apparatus 700, as described below, may further include a second reflective plate 704 so as to reflect the laser beam reflected from the first reflective plate 703 toward the glass 100. In the drawing, reference numeral 104 denotes the crack region 104 formed inside the glass 100 by a laser beam.

Referring to FIG. 5, the laser apparatus for cutting glass according to a glass cutting method of the present invention is illustrated by a cross-sectional diagram.

The first reflective plate 703 is positioned on the lower portion of the glass 100 so as to reflect the laser beam passing through the glass 100 toward the upper portion. Accordingly, the laser beam energy to be supplied to the glass is increased, so that the crack region 104 is formed more clearly during the crack region forming process and that the cutting process is performed more clearly during the full-through cutting process.

The laser apparatus 700 includes a laser source 705, a reflective mirror 706 reflecting the laser beam generated from the laser source 705 at a set angle, a collimating lens 707 collimating the laser beam that is reflected from the reflective mirror 706 in the downward direction, a focusing lens 708 adjusting the focus of the laser beam and an exterior case surrounding the laser source 705, the reflective mirror 706, the collimating lens 707 and the focusing lens 708.

As described above, according to the present invention, the second reflective plate 704 may be further attached to the lower end of the exterior case 709. Additionally, the second reflective plate 704 may have a concave shape so as to concentrate the laser beam reflected from the first reflective plate 703 in one direction, but not limited thereto.

The structured laser apparatus 700 performs either the crack region forming process or the full-through cutting process more completely due to the first and second reflective plates 703 and 704.

As described above, when forming the crack pint, the laser apparatus 700 emits the laser beam periodically. The laser beam is focused on the inside of the glass 100 by the focusing lens 708 that is coupled to the approximate center of the second reflective plate 704. Accordingly, the laser beam is emitted intermittently so as to accumulate energy inside the glass 100 and consequently to expand the emission region of the laser beam. Strong stress is generated between the expanded and unexpanded regions, so that the crack region 104 with a constant size is formed on the emission region of the laser beam.

Meanwhile, as described above, in the full-through cutting process, the laser apparatus 700 emits the laser beam continuously. The laser apparatus 700 moves in either the X direction or Y direction and simultaneously continuously emits the laser beam. Additionally, at this time, the laser beam passing through the glass 100 continues reciprocating motion between the first and second plates 703 and 704 positioned respectively on the lower portion of the glass 100 and the lower end of the laser apparatus thereby until it disappears. Accordingly, great amounts of energies accumulate in the glass 100 and the preformed crack regions 104 expand to the outer periphery. In other words, the expansion of the crack regions 104 results the full-through cutting of the glass 100.

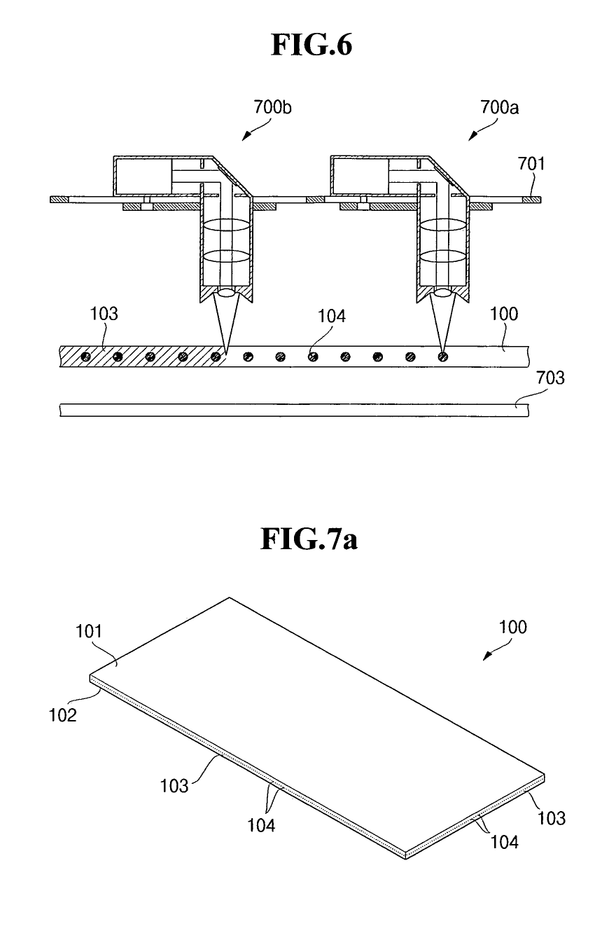

Referring to FIG. 6, another laser apparatus for cutting glass according to a glass cutting method of the present invention and the peripheral structure thereof are illustrated by a cross-sectional diagram.

Each of first and second laser apparatuses 700a and 700b may be positioned to the X directional guide rail 701. Accordingly, the first laser apparatus 700a passes by on the glass 100 first forming the crack regions 104 with a constant size and pitch and. Then, the second laser apparatus 700b directly performs the full-through cutting process along the crack regions 104. In the drawing, reference numeral 103 denotes a cutting edge formed by the second laser apparatus.

The first and second laser apparatus 700a and 700b are positioned on the one X directional guide rail 701 and performs the crack region forming and full-through cutting processes approximately at the same time. Accordingly, the glass cutting process is achieved more rapidly and more accurately.

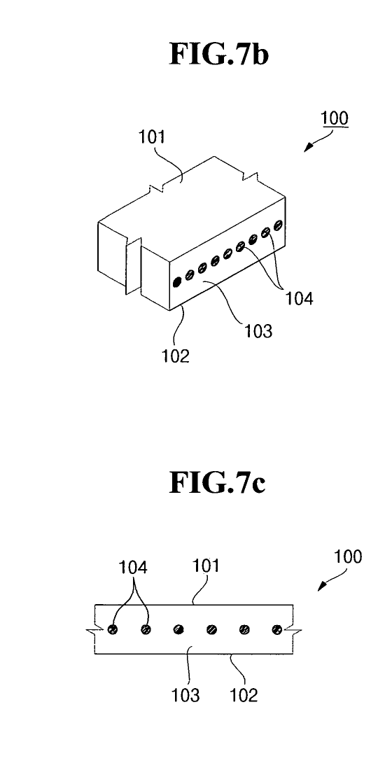

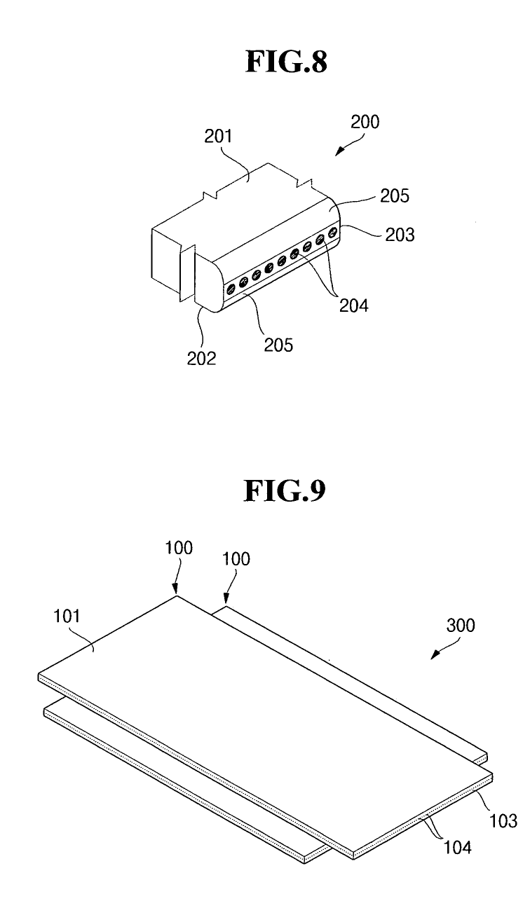

Referring to FIGS. 7a and 7b, the glass for flat panel display device according to one exemplary embodiment of the present invention is illustrated respectively by a perspective diagram and a partial expanded diagram. Referring to FIG. 7c, an outer peripheral surface thereof is illustrated by a partial expanded diagram. Referring to FIG. 8, the glass for flat panel display device according to another exemplary embodiment of the present invention is illustrated by an expanded perspective diagram.

Referring to FIGS. 7a to 7c, the glass for flat panel display device 100 includes a first planar surface 101, an approximately or completely second planar surface 102 opposite to the first surface 101, a third planar surface 103 connecting the flat first and second surfaces 101 and 102, and a plurality of crack regions 104 with a constant size and pitch formed along the third planar surface 103.

The third planar surface 103 may be formed into a rectangular-shaped belt strap along the edge of the first and second surfaces 101 and 102. The four edges of each of the first and second surfaces 101 and 102 may include either a round (not shown) or a chamfer (not shown) so as to prevent edges from being damaged or broken.

As shown in FIG. 7b, the first and third planar surfaces 101 and 103 may form a right angle. Further, the second and third planar surfaces 102 and 103 may form a right angle. Each of the first and third planar surfaces 101 and 103 and the second and third planar surfaces 102 and 103 may form a right angle.

Referring to FIG. 8, the glass for flat panel display device 200 may further include a curved surface 205 with a constant radius between first and third planar surfaces 201 and 203. Additionally, another curved surface 205 with a constant radius may be also formed between the second and third planar surfaces 202 and 203. Another curved surface 205 with a constant radius may be further formed respectively between the first and third planar surfaces 201 and 203 and the second and third planar surfaces 202 and 203 at the same time. Such curved surface 205 plays the role in preventing each border region of the first and third planar surfaces 201 and 203, and the second and third planar surfaces 202 and 203 from being damaged or broken caused by contact with manufacturing facilities in the manufacturing process of the flat panel display device.

Further, it is desirable that the crack region 104 (including the crack region 204 shown in FIG. 8) is formed in a size of approximately 1-20 μm. When the size of the crack region 104 is approximately 1 μm or less, the full-through laser cutting process may not be performed properly during the manufacturing process. Further, when the size thereof is approximately 2 μm or more, it overlaps with another neighboring crack region 104 so as to become oversized.

Further, it is desirable that the crack region 104 is formed at a pitch of approximately 5-40 μm. When the pitch of the crack region 104 is approximately 5 μm or less, several crack regions 104 overlap each other so as to become oversized. On the other hand, when the pitch of the crack region 104 is approximately 40 μm or more, the full-through laser cutting process may not be performed properly during the manufacturing process.

Further, the crack region 104 may be formed along the approximate center line of the third planar surface 103. However, actually, when the crack region 104 is formed within the range of approximately 10-90% of the thickness of the third planar surface 103 (distance between the first and second surfaces 101 and 102), the full-through laser cutting process is performed without any problem. On the other hand, when the formation position of the crack region is beyond the range of 10-90% of the thickness of the third planar surface 103 (distance between the first and second surfaces 101 and 102), the full-through laser cutting process may not be performed properly during the manufacturing process.

The thickness (distance) between the first and second surfaces 101 and 102 of the glass 100 may be approximately 0.5-5 mm, however, the present invention is not limited thereto. In other words, the glass 100 may have either a thickness of 0.5 mm or less or a thickness of 5 mm or more according to the flat panel display device.

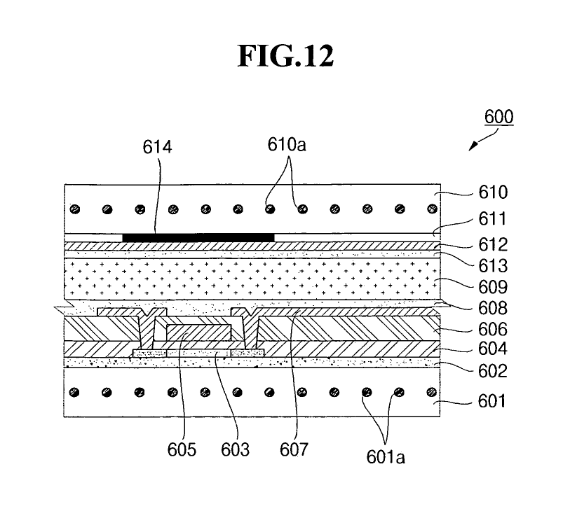

Meanwhile, the glass 100 may be used in one panel selected from a plasma display panel (referring to FIG. 11), an organic light-emitting display panel (referring to FIG. 12), a liquid crystal display panel (referring to FIG. 13), and the like, however, the present invention is not limited thereto.

FIG. 9 is a perspective diagram illustrating a status that two sheets of glass according to the present invention overlap each other.

Referring to FIG. 9, a flat panel display device 300 may be formed with two sheets of the glass 100 overlapping each other. Of course, a display unit, that is, all kinds of the organic materials, the inorganic materials or the semiconductor layers for the display may be formed between the glasses 100 which are overlapped. In addition, the display unit is completely sealed by the glasses 100. As shown in the drawing the two sheets of the glass 100 have a rectangular shape. However, the present invention is not limited thereto and the glass 100 may have a regular square shape or the like.

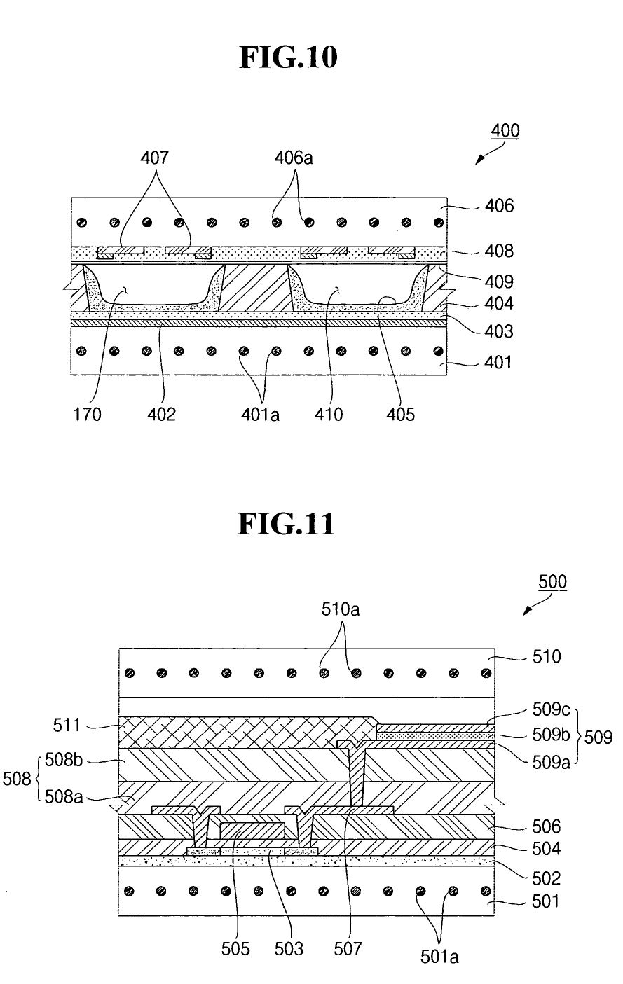

Referring to FIG. 10, a plasma display panel using the glass according to the present invention is illustrated by a partial cross-sectional diagram. Herein, the partial cross-sectional diagram shows the cross-section of other components except the glass. Particularly, the drawing shows the outer peripheral surface (lateral face) of the glass.

The plasma display panel 400 includes a first substrate 401, an address electrode 402 formed on the first substrate 401, a first dielectric layer 403 covering the address electrode 402, a barrier rib 404 formed on the first dielectric layer 403, a phosphor layer 405 formed on the first dielectric layer 403 and the barrier rib 404, a second substrate 406 formed on the barrier rib 404, a display electrode 407 formed on the second substrate 406, a second dielectric layer 408 covering the display electrode 407 and a protective layer 409.

Here, a plurality of crack regions 401a and 406a may be formed with a laser in order to be guided in the first substrate 401 and the second substrate 406, respectively. Because the diameter, the pitch and the forming location of the crack regions 401a and 406a are already enough illustrated in the above, it omits.

Referring to FIG. 11, an organic light-emitting display device panel using the glass according to the present invention is illustrated by a partial cross-sectional diagram. Herein, the partial cross-sectional diagram shows the cross-section of other components except the glass. Particularly, the drawing shows the outer peripheral surface (lateral face) of the glass.

The organic light-emitting display device panel 500 includes a first substrate 501, a buffer layer 502 formed on the first substrate 501, a semiconductor layer 503 formed on the 15 buffer layer 502, a gate oxide film 504 formed on the semiconductor layer 503, a gate electrode 505 formed on the gate oxide film 504, an interlayer insulating layer 506 covering the gate electrode 505, a source and drain electrodes 507 formed on the interlayer insulating layer 506 and coupled to the semiconductor layer 503, a protection layer 508 covering the source and drain electrodes 507, an organic light-emitting layer 509 formed on the protection layer 508 and coupled to the source and drain electrodes 507, and a second substrate 510 formed on the organic light-emitting layer 509. Here, the protection layer 508 includes an inorganic layer 508a and a planarization layer 508b. Further, the organic light-emitting layer 509 includes an anode 509a, an organic light-emitting thin film 509b and a cathode 509c in which the combination of an electron and a positive hole injected respectively from the cathode 509a and the anode 509c results light emitting. In the drawing, reference numeral 511 denotes a film for pixel definition layer.

Here, a plurality of crack regions 501a and 510a may be formed with a laser in order to be guided in the first substrate 501 and the second substrate 510, respectively. Because the diameter, the pitch and the forming location of the crack regions 501a and 510a are already enough illustrated in the above, it omits.

Referring to FIG. 12, a liquid crystal display panel using the glass according to the present invention is illustrated by a partial cross-sectional diagram. Herein, the partial cross-sectional diagram shows the cross-section of other components except the glass. Particularly, the drawing shows the outer peripheral surface (lateral face) of the glass.

The liquid crystal display panel 600 includes a first substrate 601, a buffer layer 602 formed on the first substrate 601, a semiconductor layer 603 formed on the buffer layer 602, a gate oxide film 604 covering the semiconductor layer 603, a gate electrode 605 formed on the gate oxide film 604, an interlayer insulating layer 606 covering the gate electrode 605, a source and drain electrodes 607 formed on the interlayer insulating layer 606 and coupled to the semiconductor layer 603, a first protection layer 608 covering the source and drain electrodes 607, a liquid crystal 609 formed on the first protection layer 608, a second substrate 610 formed on the liquid crystal 609, a color filter 611 formed on the second substrate 610, an opposite electrode 612 formed on the color filter 611, and a second protection layer 613 covering the opposite electrode 612. In the drawing, reference numeral 614 (not described) denotes a black matrix.

Here, a plurality of crack regions 601a and 610a may be formed with a laser in order to be guided in the first substrate 601 and the second substrate 610, respectively. Because the diameter, the pitch and the forming location of the crack regions 601a and 610a are already enough illustrated in the above, it omits.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A glass cutting method for a flat panel display device, comprising the steps of:
forming a crack region by outputting intermittently laser beams from a movable laser apparatus so that crack regions are formed inside glass; and
full-through cutting that outputs continuously laser beams from the laser apparatus along said crack region formed inside the glass so as to perform the full-through cutting of the glass.

2. The glass cutting method for the flat panel display device of claim 1, wherein the crack region forming step forms the crack region with a size of 1-20 μm using the laser apparatus.

3. The glass cutting method for the flat panel display device of claim 1, wherein the crack region forming step forms the crack region with a pitch of 5-40 μm using the laser apparatus.

4. The glass cutting method for the flat panel display device of claim 1, wherein the crack region forming step is achieved by focusing the laser beam from the laser apparatus on the internal center of the glass.

5. The glass cutting method for the flat panel display device of claim 1, wherein the crack region forming step is achieved by focusing the laser beam from the laser apparatus within the range of 10-90 % of the thickness of the glass.

6. The glass cutting method for the flat panel display device of claim 1, wherein the wavelength of the laser beam used in the crack region forming step is shorter than that of the laser beam used in the full-through cutting step.

7. The glass cutting method for the flat panel display device of claim 1, wherein the wavelength of the laser beam used in the crack region forming step is 300-400 nm, while the wavelength of the laser beam used in the full-through cutting step is 1000-1100 nm.

8. The glass cutting method for the flat panel display device of claim 1, wherein the crack region forming and full-through cutting steps are achieved by positioning a first reflective plate on the opposite surface of the laser apparatus.

9. The glass cutting method for the flat panel display device of claim 8, wherein the crack region forming and full-through cutting steps are achieved by positioning a second reflective plate on the periphery of a laser beam outlet of the laser apparatus.

10. The glass cutting method for flat panel display device of claim 9, wherein the second reflective plate has a concave shape.

11. The glass cutting method for flat panel display device of claim 1, wherein the full-through cutting step is initiated after completion of the crack forming step over the whole glass.

12. A Glass for a flat panel display device, comprising:
a first surface;
a second surface opposite to the first surface;
a third surface connecting the first and second surfaces; and
at least one crack region formed with a laser in order to act as a guide on the third surface.

13. The glass for the flat panel display device of claim 12, wherein a curved surface is formed between the first and third surface or between the second and third surface.

14. The glass for the flat panel display of claim 12, wherein the size of the crack region is 1-20 μm.

15. The glass for the flat panel display of claim 12, wherein the pitch of the crack region is 5-40 μm.

16. The glass for the flat panel display of claim 12, wherein the crack region is formed along the center line of the third surface.

17. The glass for the flat panel display of claim 12, wherein the crack region is formed within the range of 10-90% of the thickness of the third surface.

18. The glass for the flat panel display of claim 12, wherein the glass is used in one panel selected from a plasma display panel, an organic light-emitting display panel and a liquid crystal display panel.

19. A flat panel display device,comprising:
a first substrate;
a display unit which is formed in the first substrate and indicates an image; and,
a second substrate which is formed on the top of the first substrate and seals the display unit hermetically;
wherein at least one crack region is formed with a laser in order to act as a guide along the first substrate and the second substrate on each outer peripheral surface.

20. The flat panel display device of claim 19, wherein the display unit is either a plasma display panel, an organic light-emitting display panel, or a liquid crystal display panel.
